(19) United States
(12) Patent Application Publication
(10) Pub. No.: US 2009/0273585 A1
(43) Pub. Date: Nov. 5, 2009

(54) DIGITAL PEN WITH SWITCH FUNCTION

(75) Inventors: Ido Gert DE HAAN, Assen (NL); Frens MAZENIER, Veenoord (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/112,050

(22) Filed: Apr. 30, 2008

(51) Int. Cl. G06F 3/033

(52) U.S. Cl. 345/179

(57) ABSTRACT

A digital pen device used as a writing tool for inputting information to be used in a mobile telephone and as an erasing tool for erasing wrongly inputted information. The pen device may be provided with an accelerometer for identifying movements of the pen device corresponding to writing-like and erasing-like movements and an operation mode switching device for switching between different operations modes, such as writing and erasing mode dependent of the position of the pen device.

### TECHNICAL FIELD

The present invention relates to a digital pen being arranged for cooperating with an electronic device.

### BACKGROUND ART

Today, there exist many types of electronic devices such as mobile devices, media players, palmtop computers etc. Mobile devices such as mobile telephones, for example, are normally equipped with a function called short message service, SMS, i.e. a communications protocol forming part of the GSM system and allowing transmission of relatively text messages between such mobile telephones.

According to known technology, such SMS (or “text messages”) can be composed and entered by the user into the mobile telephone by using the keypad of the telephone. More precisely, characters such as letters, digits and other symbols are entered into the telephone manually by pressing the corresponding keys on the keypad.

An alternative way of entering characters forming a SMS is by using a so-called stylus, i.e. a pointed, pencil-like writing tool which is used in many of today's mobile telephones for entering characters by “writing” on a touch sensitive screen forming part of the telephone. Today, such a combination of a stylus and a “writing pad” in the form of a touch sensitive screen is relatively common and can often be regarded as more user-friendly than entering characters manually via a keypad.

Existing methods, for example entering and erasing information via a keypad or by means of a stylus cooperating with a touch screen, are not always sufficiently easy and quick to use. It can also be said that today, most mobile phones do not have a touch sensitive screen, which means that intuitive writing with a stylus is not accessible for many users.

Even though the above-mentioned known methods of entering information are relatively straight-forward for a user of a mobile device such as a mobile telephone, there is an increasing demand in the mobile telephone market for even more easy, quick and user-friendly ways of operating a mobile telephone.

In particular, with regard to SMS, there is a need to simplify the user interaction with the mobile telephone and there is a need for faster, easier and more intuitive ways of composing SMS, mms messages and e-mail messages, by means of easy and convenient input methods. Additionally, when composing messages there is also a need for simplifying the possibility to make changes in already composed messages.

### SUMMARY OF THE INVENTION

With the above and following description in mind, an aspect of certain embodiments of the present invention is to provide a device with a digital pen function adapted for being used with for example handheld, portable devices such as a mobile telephone, in which the above-mentioned drawbacks can be overcome, and which can be used for providing a more user-friendly way of editing information than previously known.

An aspect of the present invention relates to a digital pen device adapted for cooperating with a further digital device. The pen device comprises an accelerometer for detecting movement of said pen device and for providing output signals corresponding to such movements, at least a first and a second operation mode and means for selecting one of said first or second operation mode by using said output signal provided by said accelerometer.

In one embodiment, the means for selecting may be adapted for detecting a position of said pen device and for altering said operating mode upon change of position of said pen device. The position of the pen device may be detected by using said accelerometer for sensing earth gravity. Each detected position of said pen device may correspond to an operating mode.

In one embodiment, the at least first operation mode may be an input mode and the at least second operation mode may be an erase mode.

In one embodiment, the pen device may comprise a housing which is stylus shaped comprising a rear end and a back end.

In one embodiment, the pen device may be arranged for communicating with the further digital device via a wireless connection or a wired connection.

In one embodiment, the wireless connection may be arranged in accordance with the Bluetooth wireless protocol.

In one embodiment, the further device may be a mobile telephone, portable computer or similar communication device.

It is an advantage with some embodiments of the invention that they provide for an easy and intuitive way of using a digital pen device.

### BRIEF DESCRIPTION OF THE DRAWINGS

Further objects, features and advantages of the present invention will appear from the following detailed description of some embodiments of the invention, wherein some embodiments of the invention will be described in more detail with reference to the accompanying drawings, in which:

FIG. 1 shows a schematic view of a mobile phone communicating with a digital pen device which is designed according to the principles of the invention;

FIG. 2 is a schematic block diagram of a digital pen device and a mobile phone of the above-mentioned type;

FIG. 3 is a perspective view of a user using the digital pen in FIG. 1 as an erasing tool;

FIG. 4 is a schematic view of one embodiment of the digital pen device according to the invention; and

FIGS. 5a, 5b and 5c are schematic illustrations showing operational modes of the digital pen device.

### DETAILED DESCRIPTION

Embodiments of the present invention relate, in general, to the field of mobile terminals including a digital pen device. One embodiment relates to a mobile terminal, such as a mobile phone, including a digital device with pen functions. However, although the invention is particularly suitable for mobile phones, it is as such equally applicable to other electronic devices which include radio communication capabilities and the shape of the digital pen device may be of any shape. However, for the sake of clarity and simplicity, the embodiments outlined herein are related to mobile phones with a digital pen device.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to persons skilled in the art. Like reference signs refer to like elements throughout.

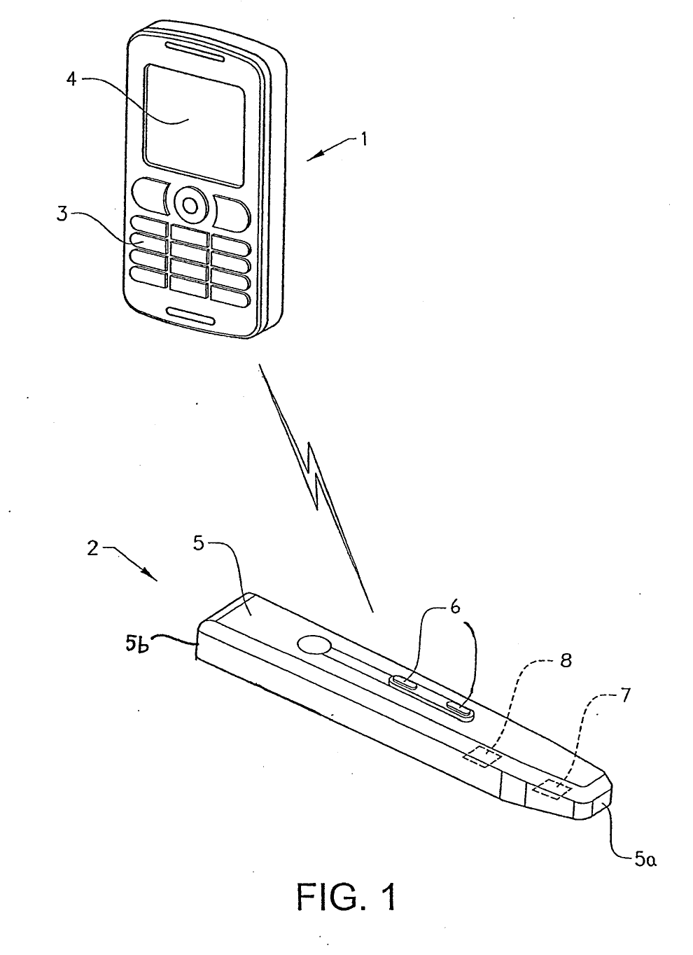

With reference to FIG. 1, there is shown a schematic view of a handheld, portable mobile telephone 1 being associated with and communicating with a digital pen device 2. The digital pen device according to the invention may equally well be used, for example, together with another device in the form of a palmtop computer, an electronic game unit, a media player (for example a so-called mp3 player), a smartphone, a handheld DVD player, a pager and similar devices.

In a conventional manner, the mobile phone 1 is provided with a keypad 3 and a display 4. The mobile phone 1 is also arranged for communicating with the digital pen device 2. As indicated schematically in FIG. 1, the communication between the mobile phone 1 and the digital pen device 2 may be wireless, by means of a wireless communications protocol such as for example the Bluetooth wireless protocol. The manner in which different units communicate via the Bluetooth protocol is previously known as such, and for this reason it will not be described in detail here. The communication may also be wired by means of a wired communication line between a mobile phone and the digital pen device i.e. the invention is not limited to wireless communication between a mobile unit and the digital pen device.

It can furthermore be noted that the principles of the present invention can also be implemented in headsets being connected to a mobile unit.

As shown in FIG. 1, the digital pen device 2 comprises a housing 5 which is elongated, i.e. having a design with notably more length than width, like a stylus.

The digital pen device 2 is shown in FIG. 1 in a slightly simplified manner. It is apparent that a digital pen device 2 such as the one shown in FIG. 1 may comprise user interface controls such as buttons, switches and similar components, 6.

A digital pen device 2 may be used as a writing tool for inputting information to be used in the mobile telephone 1. For example, such information that can be used in a short message service function (hereinafter referred to as a “SMS” function).

In one embodiment of the invention the digital pen device 2 is further arranged as an erasing tool for erasing wrongly inputted information to be used in the mobile phone 1. For example, to be able to recompose, change, edit or delete part of the already inputted information in e.g. a SMS.

For this reason, the pen device 2 according to the embodiment shown in FIG. 1 is provided with an accelerometer 7 for identifying movements of the pen device 2 corresponding to writing-like and erasing-like movements and an operation mode switching device 8 for switching between different operations modes, such as writing and erasing mode dependent of the position of the pen device. The position of the pen device may be detected by sensing the earth gravity by using the accelerometer 7.

When the pen device is in writing mode, as described above, the detected writing-like movements are transformed into characters, symbols or other information to be fed into the mobile telephone 1 and used for example for the SMS.

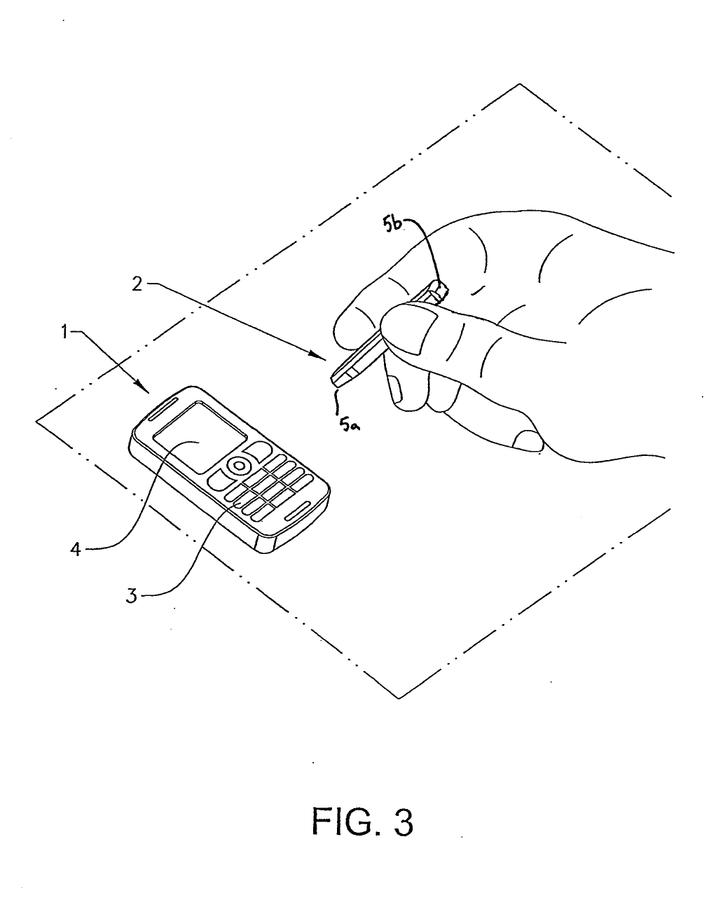

When the pen device is in erasing mode, as described above, the pen device 2 is arranged for converting erasing-like movements into erasing earlier entered characters and symbols. This can be achieved if the pen device 2 is used to “erase” onto a surface, as shown in FIG. 3, or if it is used for making such movements in the air, i.e. without contacting any surface. Alternatively, the pen device 2 can also be used for erasing on a surface such as a screen on a mobile telephone.

While erasing whole or parts of messages as described above, the characters are suitably deleted in real-time on the display 4 of the mobile telephone 1 (e.g. in the SMS composing window).

According to one embodiment of the invention, the housing 5 is shaped generally as a pen, i.e. having an elongated design with a pointed end portion 5a similar to the tip of a pencil. However, the invention is not limited to any particular type of shape or design of the housing 5.

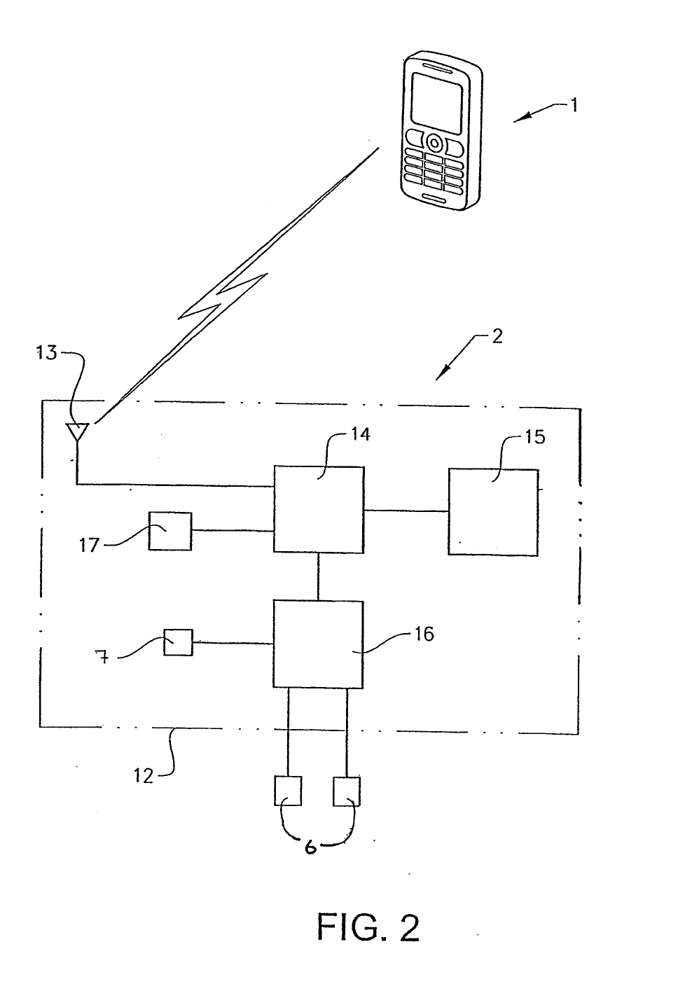

The manner in which the accelerometer 7 is arranged in order to use the pen device 2 as a writing/erasing tool will now be described with further reference to FIG. 2, which is a block diagram of a number of components forming part of the pen device 2 and the mobile telephone 1 of the above-mentioned type.

FIG. 2 shows a block diagram of a pen device control unit 12 which is preferably mounted as an integrated unit inside the housing 5 of the pen device 2. The control unit 12 comprises an antenna 13 which is arranged for communicating with the mobile telephone 1, suitably via the Bluetooth wireless protocol as mentioned above. The antenna 13 is connected to a microprocessor 14 arranged for controlling the transmission of signals between the pen device 2 and the mobile telephone 1.

Furthermore, the above-mentioned accelerometer 7 is connected to an I/O (input/output) unit 16. The accelerometer 7 is used for providing input signals indicating movements of the housing 5 along a generally horizontal plane (x and y directions) or alternatively movements both along a horizontal plane and also along a vertical direction (z direction), i.e. transversal to both the x and y directions. Such signals can be used in order to detect a pattern of movement of the pen device 2. More precisely, when a user moves the pen device 2 in a fashion similar to writing with a pencil, the accelerometer 7 will output a signal corresponding to the direction of movement and the acceleration of the movement. This signal is fed to the microcontroller 14 and is used to recognize characters, numbers and other symbols corresponding to such “writing” movements of the pen device 2.

One way of recognizing and identifying which symbols correspond to the movements of the pen device 2, the microcontroller 14 is suitably connected to a character recognition unit 17 for translating the signals from the accelerometer 7 corresponding to the movements of the pen device 2 (i.e. the “writing” by means of the pen device 2) into corresponding symbols and other pieces of information.

One way of recognizing and identifying the movement of the pen device 2 corresponding to erase movements, the microcontroller 14 is suitable connected to an erase unit 15 for translating the signals from the accelerometer 7 corresponding to erase movements of the pen device 2 into deleting or erasing earlier inputted information.

The microcontroller 14 of the pen device 2 is arranged for outputting and transmitting to the mobile telephone 1 signals corresponding to information being formed by the movements of the pen device 2. The mobile phone 1 is arranged for receiving the signals from the pen device 2, preferably via the Bluetooth protocol as described above. The signals from the pen device 2 are used as input information in the form of writing or erasing characters or symbols to various functions of the mobile telephone 1.

The accelerometer 7 can be of conventional type and being, for example, of capacitive, piezoelectric or piezoresistive type. An accelerometer to be used within the frame of this invention is generally arranged to sense and convert an external acceleration force acting on the housing 5 and being detected from a motion. Such motion would result from movement of the housing 5 in a manner similar to writing with a pencil. Due to the shape of the housing (cf. FIG. 1), it can be held with a grip just like a pencil so that the pointed end part 5a of the housing 5 would simulate a tip of a pencil and the other end part 5b of the housing would simulate a rubber part of a pencil. When writing the message (such as when composing an SMS), the user will hold the headset in one hand and have it positioned in a hand similar to a ballpoint pen.

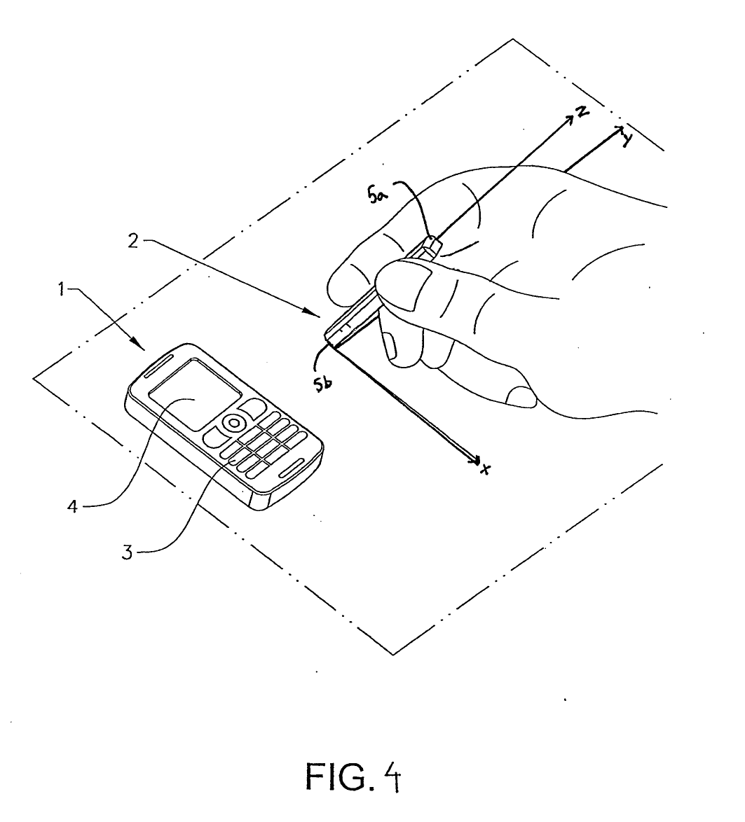

As shown in FIG. 4, an accelerometer of the 3D type is used, i.e. indicating movements in a plane, above defined as an x-y plane, and in a z direction, i.e. “up and down”. This means that writing/erasing movements of the pen device 2 along a generally horizontal plane (not shown) can be detected. Such a situation would correspond to a user “writing” or “erasing” with the pen device 2 on a surface such as a table or a separate writing pad. As an alternatively, the mobile telephone 1 can be equipped with a screen having dimensions and a design allowing it to be used as a writing pad. This means that the user would use the pen device 2 for writing/erasing movements directly on such a screen. Since the accelerometer is of the 3D type, also movement in a z direction, i.e. “up and down” or “upside down” can be detected. By means of detecting acceleration in each of the three axes the pen device will be able to identify when the position of the pen device is changed.

In a further embodiment, if the pen device is in the hand of a user and being gripped generally in the same manner as a pencil, with it's pointed end 5a pointed towards a surface on which the mobile telephone 1 is placed, as shown in FIG. 3, the accelerometer detects the writing position of the pen device and the pen device is put in the writing operation mode. When the accelerometer detects a movement in the x-y plane, writings or drawings is detected and inputted. If the pen device 2 is being turned upside down in the hand of a user and still being gripped generally in the same manner as a pencil, with it's rear end 5b pointed towards a surface on which the mobile telephone 1 is placed, as shown in FIG. 4, the accelerometer detects a turning movement into the erasing position and the pen device is put in the erasing operation mode. When the accelerometer detects a movement in the x-y plane, inputted writings or drawings is erased or deleted. When the accelerometer detects a movement upwards in the z-direction the writing operation mode or erasing mode is stopped or paused.

In another embodiment according to the invention, a movement or change of position may be made around or along any of the three axes, x, y or z, which may trigger alteration of an operation mode of the pen device. There may be at least two different operation modes of the pen device according to the invention. Examples of operation modes may be writing regular, writing underlined, writing thick, writing italic, drawing thin lined, drawing thick lined, erasing thin lined, erasing thick lined etc. Each time the accelerometer of the pen device detects a movement into another position the operation mode is switched.

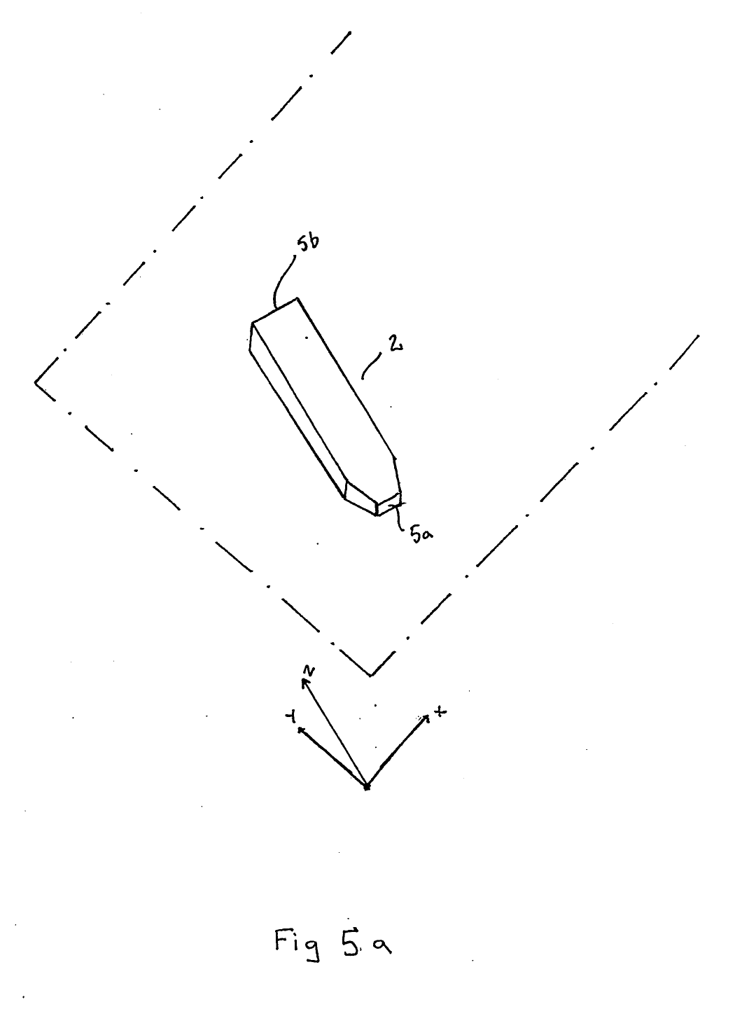

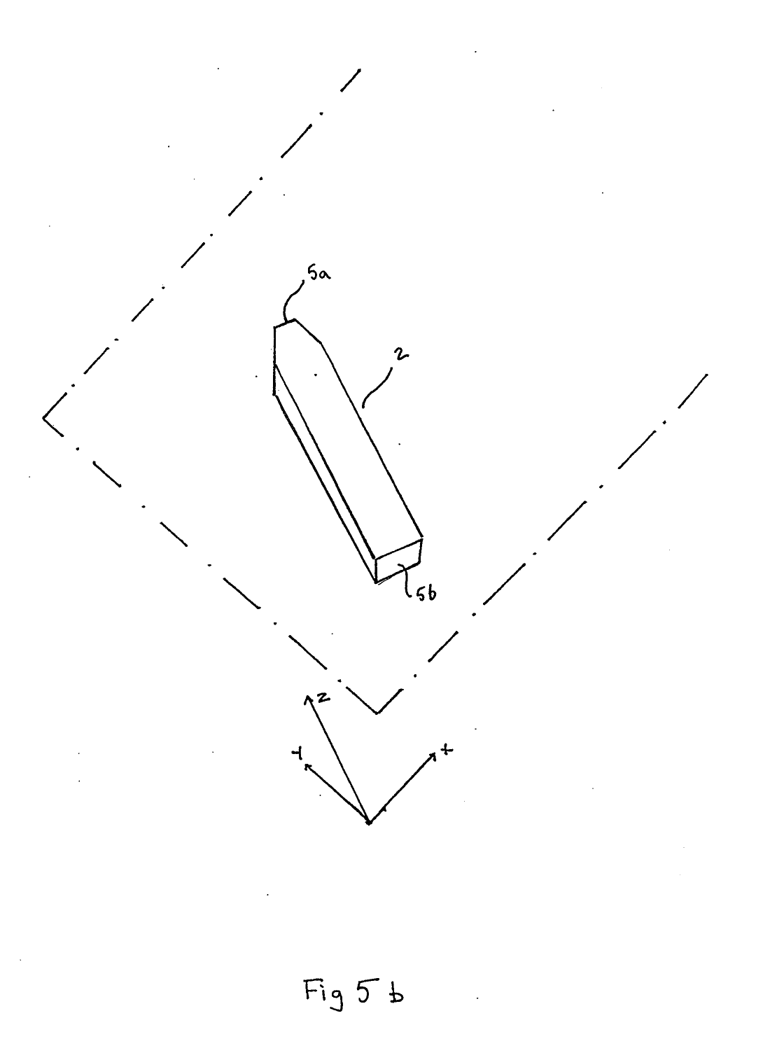

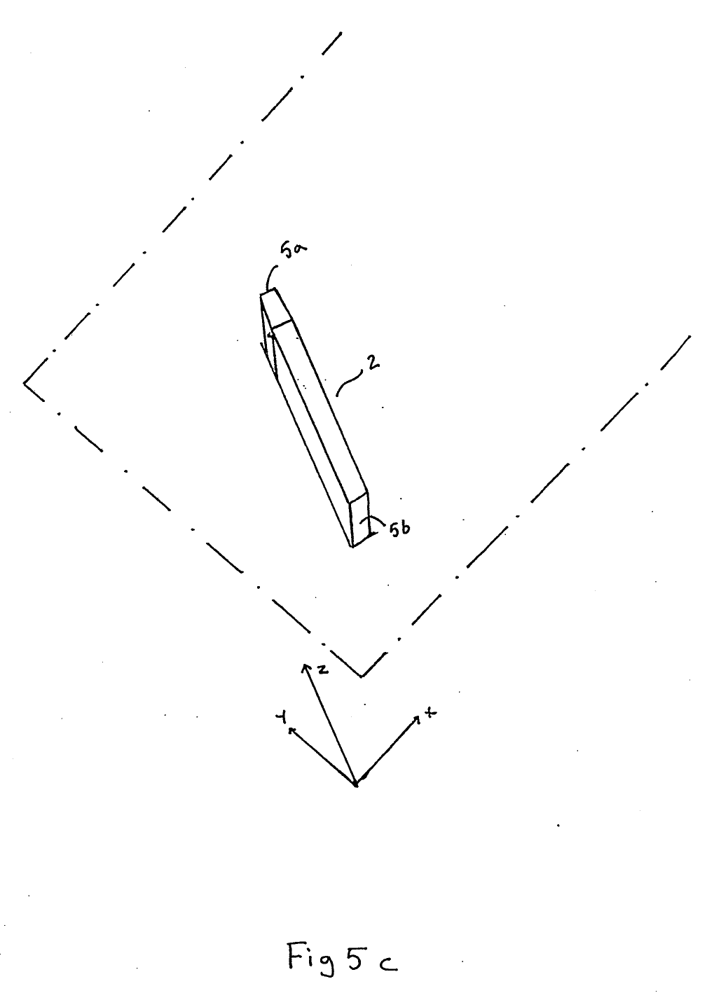

As an example, as shown in FIG. 5a-c, the pen device shaped as a marker pen, when the pen device is hold in a first position the operation mode is in writing regular mode, as shown in FIG. 5a. When the pen device is turned upside down, in z-direction, into a second position, the operation mode is changed into erase thin lined mode, as shown in FIG. 5b. Further on, when the pen device is turn to the left, in y-direction, to a third position (FIG. 5c), the operation mode is changed into erase thick lined mode. There may be other combinations of positions corresponding to different operation mode.

Generally, the invention is useful for all types of electronic devices which are associated with or connected to digital pen devices and having controls for inputting and erasing characters and symbols on the device.

The invention is not limited to the embodiment described above, but may be modified without departing from the scope of the claims below. For example, the invention can be used in portable, handheld terminals such as mobile phones, but is not limited to this type of use only but can be used in media players, computers, smart phones, game units, DVD players, pagers and similar devices. In fact, the invention can be used in generally any devices or terminals communicating with a digital pen device and where there is a need for erasing information by means of movement similar to erasing.

Furthermore, it should be mentioned that the interpretation of the movement data, as detected by the accelerometer 7, can be done by algorithms inside the pen device control unit 12, i.e. in the recognition unit 17 but can also be done by algorithms in the mobile telephone 1.

According to an embodiment of the invention, it can be implemented in a headset of a type which only comprises an earphone, i.e. which is not provided with a microphone. Such a headset may be used together with a game unit, a media player or an FM radio, for example, where there normally is no need for inputting audio signals via a microphone in the headset.

The invention may be implemented by suitable combinations of software and hardware as is known in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A digital pen device adapted for cooperating with a further digital device, wherein said pen device comprises
an accelerometer for detecting movement of said pen device and for providing output signals corresponding to such movements;
at least a first and a second operation mode; and
means for selecting one of said first or second operation mode by using said output signal provided by said accelerometer.

2. The pen device according to claim 1, wherein said means for selecting is adapted for detecting a position of said pen device and for altering said operating mode upon change of position of said pen device.

3. The pen device according to claim 2, wherein said position is detected by using said accelerometer for sensing earth gravity.

4. The pen device according to claim 2, wherein each detected position of said pen device corresponds to an operating mode.

5. The pen device according to claim 1, wherein said at least first operation mode is an input mode and said at least second operation mode is an erase mode.

6. The pen device according to claim 1, wherein said pen device comprises a housing which is stylus shaped comprising a rear end and a back end.

7. The pen device according to claim 1, wherein the pen device is arranged for communicating with said further digital device via a wireless connection.

8. The pen device according to claim 7, wherein the wireless connection is arranged in accordance with the Bluetooth wireless protocol.

9. The pen device according to claim 1, wherein the pen device is arranged for communicating with said further digital device via a wired connection.

10. The pen device according to claim 1, wherein said further device is a mobile telephone, portable computer or similar communication device.
